(19) United States
(12) Patent Application Publication
(10) Pub. No.: US 2006/0174897 A1
(43) Pub. Date: Aug. 10, 2006

(54) Apparatus and method for caring for obstructive sleep disorder breathing

(76) Inventor: Edvard Sarkisian, Glendale, CA (US)

Correspondence Address: PETER GANJIAN, 3146 NORTH VERDUGO ROAD, GLENDALE, CA, 91208, US

(21) Appl. No.: 11/055,769

(22) Filed: Feb. 10, 2005

(51) Int. Cl. A61C 5/14

(52) U.S. Cl. 128/859; 128/861

(57) ABSTRACT

The present invention provides an adjustable connection mechanism 200 for releasabley coupling two components. The adjustable connection mechanism 200 comprises a first retention guide channel 202 coupled to a surface of a first component, a second retention guide channel 204 oriented substantially perpendicular to the first retention guide channel 202 and coupled to a surface of a second component that faces the surface of the first component, an adjuster 206 removabley inserted in the first retention guide channel 202, and an interlocking member 208 releasabley fastening the two retention guide channels 202 and 204.

### BACKGROUND OF THE INVENTION

(1) Field of the Invention

This invention relates to an orally retained device for caring for patients with obstructive sleep disorder breathing (OSDB), and more particularly, to an intra-oral device worn for caring of obstructive sleep apnea (OSA).

(2) Description of Related Art

Sleep apnea is a group of serious sleep disorders in which a sleeping person repeatedly stops breathing (apnea) long enough to decrease the amount of oxygen in the blood and brain, and to increase the amount of carbon dioxide. An obstructive sleep apnea (OSA) is caused by a blockage in the throat or upper airway. The most common symptom of OSA is snoring associated with episodes of gasping, choking, pauses in breathing, and episodes of sudden awakening.

As disclosed in the U.S. Pat. Nos. 5,365,945, 6,041,784, and 6,161,542, all to Halstrom, snoring and obstructive sleep apnea is typically caused by complete or partial obstruction of an individual's pharyngeal airway during sleep. Usually, airway obstruction results from the apposition of the rear portion of the tongue or soft palate with the posterior pharyngeal wall. Snoring occurs when the pharyngeal airway is partially obstructed, resulting in vibration of the oral tissues during respiration. These sleep disorders tend to become more severe as patients grow older, likely due to a progressive loss of muscle tone in the patient's throat and oral tissues.

The prior art FIG. 1A is a schematic, side elevation view of the upper pharyngeal region of a typical patient suffering from obstructive sleep apnea or snoring, which is also disclosed in U.S. Pat. Nos. 5,365,945, 6,041,784, and 6,161,542, all to Halstrom. When the patient is asleep the oral cavity tissues relax and the distal (rear) portion of the tongue 100 tends to slide rearwardly toward the posterior pharyngeal wall 102. This may result in partial or complete occlusion of the pharyngeal airway 104 in the circled region 106. As the volume of airway 104 diminishes, the velocity of the air passing the oral cavity tissues tends to increase. This may result in vibration of the oral cavity tissues, such as the uvula 108, which is a fleshy projection suspended from the soft palate 110 over the root of tongue 100. The vibration of these oral tissues causes the snoring sound.

A variety of non-surgical approaches for treating sleep disorders have been proposed, including the use of oral cavity appliances. It has been previously recognized that movement of the mandible (lower jaw) forward relative to the maxilla (upper jaw) can eliminate or reduce sleep apnea and snoring symptoms by causing the pharyngeal air passage to remain open. Several intra-oral dental appliances have been developed that a user wears at night to fix the mandible in an anterior, protruded (i.e., forward) position. Such dental appliances essentially consist of acrylic or elastomeric bite blocks, similar to orthodontic retainers or athletic mouth-guards, which are custom-fitted to the user's upper and lower teeth and which may be adjusted to vary the degree of anterior protrusion.

The prior art FIG. 1B is a schematic, side elevation view of the individual of prior art FIG. 1A fitted with a prior art dental appliance 120 of Halstrom. Dental appliance 120 causes the individual's mandible 118 to be moved to an anterior, protruded position relative to the upper jaw 112. This causes the dorsal surface of the tongue 100 to move forwardly away from the posterior pharyngeal wall 102. This in turn results in an increase in volume of the pharyngeal airway 104 as shown in the circled region 106. It has been shown that maintaining airway 104 substantially open during sleep alleviates the undesirable symptoms associated with obstructive sleep apnea and snoring.

To summarize, appliance 120 consists of an upper bite block 126 shaped to conform to the maxillary dentition 114 and a lower bite block 124 shaped to conform to the mandibular dentition 116. In general, bite blocks 126 and 124 are constructed from an elastomeric material. Each bite block 126 and 124 includes stainless steel dental wires to stabilize appliance 120 and ensure that it securely engages the wearer's teeth. The posterior region of each bite block 126 and 124 includes hard acrylic bite pads 128 and 130 that provide a stop to the closure of the jaw and that support the wearer's tempro-mandibular joint. The two retention plates and a guide box assembly (not shown) are connected by means of a stylus 122.

Problems and difficulties encountered with most conventional intra-oral appliances, including those taught by the U.S. Pat. Nos. 5,365,945, 6,041,784, and 6,161,542, all to Halstrom, stem from the use of multiplicity of parts and elements necessary to mount, connect, and use the appliance. The conventional assemblies employ sidebars, clasps, wires, screw mechanisms, and many other parts that are complicated to assemble and require constant, professionally administered maintenance. In addition, most of the conventional intra-oral appliances do not allow for different vertical settings, nor do they allow for lateral movement of the lower jaw, as well as allowing for anterior and posterior adjustability.

A further complication with the conventional intra-oral appliances is the required precise laboratory fit within a patient's mouth by a professional laboratory technician. That is, to use the intra-oral appliance for airway dilation, they must be correctly fitted to a patient's mouth. The complicated processes for the accurate fitting of a prior art intra-oral appliance commences with making an exact impression (or mold) of the patient's existing maxillary and mandibular dentitions at a doctor's office, and forwarding the impression to a dental laboratory for manufacturing and assembly of the intra-oral appliance by a professional laboratory technician. In most cases, the patient is then returned to the physician for fitting, and is further required to return for follow-up appointments, which may include further adjusting of the intra-oral appliance to achieve the optimum setting for the airway dilation. Not so highly adjustable, inexpensive, intra-oral appliances do exist, but they are limited in that they may be used for only several nights, are not highly adjustable, and may still comprise of many complex connection components. Others with a slightly longer average life use a well known boil-and-fit technique for correct fitting of the intra-oral appliance into a patients mouth, but these also have limited adjustability, and some have many complicated connection components.

Therefore, the traditional intra-oral appliances for caring of OSA and snoring patients have many complex small parts that are difficult to assemble, and require the help of many professionals with special tools for assembly and fitting, and are not highly adjustable in lateral, vertical, anterior and posterior positions. In light of the current state of the art and the drawbacks to current devices and methods mentioned above, a need exists for an intra-oral appliance for caring of OSA and snoring patients that would allow for the lateral, vertical, anterior, and posterior adjustment of the mandible position for an improved airway dilation, and that would have few parts that are readily assembled without the necessity for special tools. In addition, a need exists for an intra-oral appliance that would not require the help of many professionals (e.g. dental laboratory technicians) with special tools for its assembly and fitting.

### BRIEF SUMMARY OF THE INVENTION

The present invention provides an intra-oral device for OSA and snoring patients that has few parts, easily assembles, and does not require a plethora of professionals for proper use and fitting.

One aspect of the present invention provides an apparatus, comprising:
a connecting mechanism for releasably coupling a maxillary member and a mandibular member, including:
a primary retention guide for coupling to one of the maxillary member and the mandibular member, axial to oral cavity;
a secondary retention guide for coupling to the other one of the maxillary member and the mandibular member, with the secondary retention guide oriented substantially perpendicular to the primary retention guide;
a mandibular adjuster comprised of titanium alloy, having a mandibular adjuster safety lock handle at a madibular adjuster proximal end, removably inserted into the primary retention guide for incremental movement of a mandible; and
an interlocking member having a pin for removable insertion in an at least one mandibular adjuster aperture, and having an anchor piece for removable insertion into the primary retention guide, and having a head for removable insertion into the secondary retention guide;
whereby the connecting mechanism allows for vertical, lateral, anterior, and posterior movement of the mandible.

Another optional aspect of the present invention provides an apparatus wherein the maxillary member includes a maxillary member top surface and a maxillary member bottom surface customized for conforming to an individual's maxillary dentition; and
the mandibular member includes a mandibular member top surface and a mandibular member bottom surface customized for conforming to an individual's mandibular dentition.

Yet another optional aspect of the present invention provides an apparatus, wherein the maxillary member includes a maxillary frame having a maxillary frame top surface and a maxillary frame bottom surface for conforming to a maxillary oral arch; and
the mandibular member includes a mandibular frame having a mandibular frame top surface and a mandibular frame bottom surface for conforming to a mandibular oral arch.

A further optional aspect of the present invention provides an apparatus, wherein the maxillary frame top surface includes maxillary top surface side walls forming a maxillary top surface channel for containing impression material that can conform to maxillary dentition, and
the mandibular frame top surface includes mandibular top surface side walls forming a mandibular top surface channel for containing impression material that can conform to mandibular dentition.

Yet a further optional aspect of the present invention provides an apparatus, wherein the impression material is comprised of one of a quick impression material and a boil-and-fit material that cures at room temperature.

Still a further optional aspect of the present invention provides an apparatus, wherein the primary retention guide includes a primary retention guide bottom side that is integral with and normal to two parallel primary retention guide walls.

Another optional aspect of the present invention provides an apparatus, wherein the primary retention guide includes a primary retention guide bottom side that is integral with and normal to two parallel primary retention guide walls, with the primary retention guide bottom side and the two primary retention guide walls enclosed within one of the maxillary member bottom surface and the mandibular member bottom surface.

Yet another optional aspect of the present invention provides an apparatus, wherein the primary retention guide includes a primary retention guide bottom side that is integral with and normal to two parallel primary retention guide walls, with the primary retention guide bottom side and the two primary retention guide walls enclosed within one of the maxillary frame bottom surface and the mandibular frame bottom surface.

Still another aspect of the present invention provides an apparatus, wherein the secondary retention guide includes a secondary retention guide bottom side that is integral with and normal to two secondary retention guide walls.

A further optional aspect of the present invention provides an apparatus, wherein the secondary retention guide includes a secondary retention guide bottom side that is integral with and normal to two secondary retention guide walls, with the secondary retention guide bottom side and the two secondary retention guide walls enclosed within one of the maxillary member bottom surface and the mandibular member bottom surface.

Yet further optional aspect of the present invention provides an apparatus, wherein the secondary retention guide includes a secondary retention guide bottom side that is integral with and normal to two secondary retention guide walls, with the secondary retention guide bottom side and the two secondary retention guide walls enclosed within one of the maxillary frame bottom surface and the mandibular frame bottom surface.

Still a further optional aspect of the present invention provides an apparatus, wherein the primary retention guide is comprised of an elongated primary retention guide open channel that is defined by the primary retention guide bottom side, the two primary retention guide walls, and two opposing primary retention guide flanges that are integral with and normal to the two primary retention guide walls.

Another optional aspect of the present invention provides an apparatus, wherein at least one primary retention guide flange top surface, exterior to the elongated primary retention guide open channel includes incremental indicators for gauging the incremental move of the mandible to one of an anterior and a posterior positions.

Yet another optional aspect of the present invention provides an apparatus, wherein the secondary retention guide is comprised of an elongated secondary retention guide open channel that is defined by the secondary retention guide bottom side, the two secondary retention guide walls, and two opposing secondary retention guide flanges that are integral with and normal to the two secondary retention guide walls.

Still another optional aspect of the present invention provides an apparatus, wherein the primary retention guide walls are comprised of primary retention guide wall openings at a primary retention guide wall proximal end for receiving a protruded piece of the mandibular adjuster.

A further optional aspect of the present invention provides an apparatus, wherein the primary retention guide walls are further comprised of primary retention guide side bars, which are integral with and are axially along a middle of the primary retention guide walls, exterior to the elongated primary retention guide open channel.

Still a further optional aspect of the present invention provides an apparatus, wherein the secondary retention guide walls are further comprised of secondary retention guide side bars, which are integral with and are axially along a middle of the secondary retention guide walls, exterior to the elongated secondary retention guide open channel.

Another optional aspect of the present invention provides an apparatus, wherein the primary retention guide side bars are further comprised of at least one cutout section along a primary retention guide side bar length.

Yet another optional aspect of the present invention provides an apparatus, wherein secondary retention guide side bars are further comprised of at least one cutout section along a secondary retention guide side bar length.

Still another optional aspect of the present invention provides an apparatus, wherein at least two of a primary retention guide bottom side perimeters of the primary retention guide bottom side extend beyond the primary retention guide walls.

A further optional aspect of the present invention provides an apparatus, wherein at least two of a secondary retention guide bottom side perimeters of the secondary retention guide bottom side extend beyond the secondary retention guide walls.

Yet a further optional aspect of the present invention provides an apparatus, wherein the at least two of the primary retention guide bottom side perimeters include at least one cutout section.

Still a further optional aspect of the present invention provides an apparatus, wherein the at least two of the secondary retention guide bottom side perimeters include at least one cutout section.

Another optional aspect of the present invention provides an apparatus, wherein a primary retention guide proximal end of the primary retention guide is curved to conform to an oral arch.

Yet another optional aspect of the present invention provides an apparatus, wherein a primary retention guide distal end of the primary retention guide and a secondary retention guide distal end of the secondary retention guide is partially closed.

Still another optional aspect of the present invention provides an apparatus, wherein a secondary retention guide channel inner circumference of the secondary retention guide is configured as one of a round, rectangular, square, and oval forms.

A further optional aspect of the present invention provides an apparatus, wherein the mandibular adjuster is comprised of:
a support base;
a midsection having at least one aperture, comprising a midsection distal end integral with and forming a first side of the support base, and further comprising a midsection proximal end;
a first flexible arm having a first flexible arm distal end integral with a second side of the support base, and a free, first flexible arm proximal end for allowing movement of the first flexible arm inwardly towards the midsection;
a second flexible arm having a second flexible arm distal end integral with a third side of the support base, and a free, second flexible arm proximal end for allowing movement of the second flexible arm inwardly towards the midsection;
whereby the first and the second flexible arms are moved for allowing the mandibular adjuster to be removabley inserted into the primary retention guide.

Yet a further optional aspect of the present invention provides an apparatus, wherein the first flexible arm proximal end includes a first flexible arm tab and a first flexible arm nub, and the second flexible arm proximal end includes a second flexible arm tab and a second flexible arm nub,
whereby the first flexible arm tab and the second flexible arm tab are used for griping and for moving the first flexible arm and the second flexible arm inwardly towards the midsection of the mandibular adjuster for allowing insertion and removal of the mandibular adjuster within the primary retention guide; and
whereby the first flexible arm nub and the second flexible arm nub are used for engaging the mandibular adjuster with the primary retention guide wall openings for removabley securing the mandibular adjuster to the primary retention guide.

Still a further optional aspect of the present invention provides an apparatus, wherein the mandibular adjuster safety lock handle having a safety handle proximal end integral with one of the first flexible arm proximal end and the second flexible arm proximal end, and a free safety handle distal end;
whereby the free safety handle distal end blocks the inward movement of the first flexible arm and the second flexible arm towards the midsection when the free safety handle distal end is at a rest position.

Another optional aspect of the present invention provides an apparatus, wherein the free safety handle distal end allows the inward movement of the first flexible arm and the second flexible arm towards the midsection when the free safety handle distal end is at an extended, open position.

Still another optional aspect of the present invention provides an appratus, wherein the mandibular adjuster is comprised of:
a support base having a support hole through a first side of the support base for inserting a support wire through;
a midsection having at least one aperture, comprising a midsection distal end integral with a second side of the support base for forming two female receiving couplers, and a midsection proximal end having a midsection hole through a midsection length for inserting a spring wire through;
two arms having an arm proximal end for connection to the spring wire and an arm distal end comprised of a male coupler for frictionally mating the support base female receiving couplers;
the arm distal end male coupler of the two arms having a cutout section for forming a passage for allowing the support wire to pass through the passage for preventing a disjoining of the arms from the support base;
whereby the spring wire connection at the arm proximal end and the frictionally coupled arm distal end allow for movement of the two arms inwardly towards the midsection for allowing the mandibular adjuster to be inserted into the primary retention guide.

Another optional aspect of the present invention provides an appratus, wherein the intra-oral device further includes a removable safety cap conformed to fit a mandibular adjuster proximal end, and covering a primary retention guide proximal end, including an interlocking safety string placed around the interlocking member for securing the mandibular adjuster inside the primary retention guide;

Still another optional aspect of the present invention provides an appratus, wherein the safety cap is comprised of thermoplastic material.

Yet another optional aspect of the present invention provides an apparatus, wherein the anchor piece of the interlocking member is coupled to the pin and a first end of an interlocking member support, with the interlocking member support comprised of a cylinder.

Still another optional aspect of the present invention provides an apparatus, wherein the head of the interlocking member is coupled to a second end of an interlocking member support, with an outer form of the head of the interlocking member configured as one of a round, rectangular, square, and oval forms.

A further optional aspect of the present invention provides an apparatus, wherein the connection mechanism, including the primary retention guide, the secondary retention guide, and the interlocking member are comprised of titanium alloy.

Yet a further optional aspect of the present invention provides an apparatus, wherein the connection mechanism, including the primary retention guide, the secondary retention guide, and the interlocking member are comprised of thermoplastic material.

Still a further optional aspect of the present invention provides an apparatus, wherein the thermoplastic material is comprised of polyketones.

Another optional aspect of the present invention provides an apparatus, wherein the polyketones include one of polyaryletherketones (PEK), polyetheretherketones (PEEK), and polyetherketoneketones (PEKK) material.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention.

Referring to the drawings in which like reference character(s) present corresponding parts throughout:

FIG. 1A is an exemplary prior art schematic, side elevation view of the upper pharyngeal region of a typical patient suffering from obstructive sleep apnea or snoring;

FIG. 1B is an exemplary prior art schematic, side elevation view of the patient of FIG. 1A fitted with a prior art dental appliance to maintain the patient's mandible in a protruded position, thereby averting obstruction of the pharyngeal airway;

FIG. 2A is an exemplary front perspective view illustrating the novel intra-oral device with a frist connection orientation in accordance with the present invention;

FIG. 2B is an exemplary front perspective view illustrating the novel intra-oral device with a second connection orientation in accordance with the present invention;

FIG. 2C is an exemplary enlarged perspective view of an intra-oral device as used in the embodiment shown in FIG. 2A in accordance with the present invention;

FIGS. 3A to 3D are exemplary illustrations for the intra-oral device coupled to a maxillary frame and a mandibular frame in accordance with the present invention;

FIGS. 3E to 3H are exemplary illustrations for the top surfaces of maxillary and mandibular frame, including the use of impression material in accordance with the present invention;

FIGS. 4A to 4C are exemplary enlarged illustrations for the various embodiments for the primary retention guide illustrated in FIGS. 2A and 2B in accordance with the present invention;

FIGS. 5A to 5F are exemplary enlarged illustrations for the various embodiments for the secondary retention guide illustrated in FIGS. 2A and 2B in accordance with the present invention;

FIGS. 6A to 6E are exemplary enlarged illustrations for the various embodiments for the mandibular adjuster illustrated in FIGS. 2A and 2B in accordance with the present invention; FIGS. 6F and 6G are exemplary illustrations of the mandibular adjuster of FIG. 6B with a primary retention guide of FIG. 4A in accordance with the present invention;

FIGS. 7A and 7B are exemplary enlarged illustrations for an optional safety cap used with particular embodiments of a mandibular adjuster that are illustrated in FIGS. 6A, 6D, and 6E in accordance with the present invention;

FIGS. 8A to 8F are exemplary enlarged illustrations for the various embodiments for the interlock member illustrated in FIGS. 2A and 2B in accordance with the present invention; and

FIGS. 9A to 9G are exemplary enlarged illustrations that show a sectional view of the primary retention guide and the interlock member, taken in the direction of arrows 9-9 of FIG. 2C, in accordance with the present invention.

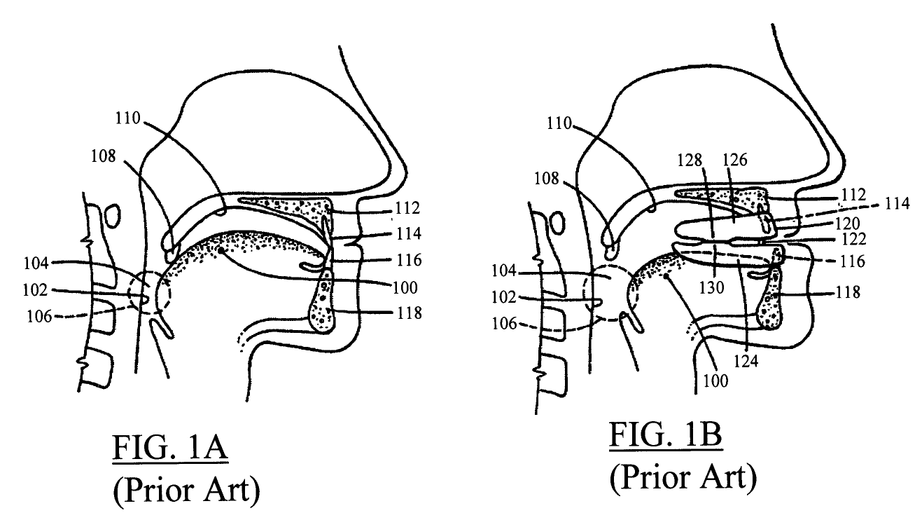

### DETAILED DESCRIPTION OF THE INVENTION

(1) Introduction

Most conventional connection mechanisms for intra-oral appliances are comprised of numerous, complex parts that require a professional to assemble and adjust. The present invention provides a simple, adjustable connection mechanism comprised of only four components that are easily assembled, and may be adjusted and used without the need for special tools or professionals.

Before providing details regarding the various aspects of the invention, first an overview of the present invention is provided, which describes the interconnections and operation of various major components in order to provide a more tangible understanding thereof without getting lost in the details. Next, an explicatory section is provided in which the various major components presented in the overview are described in detail.

(2) Overview

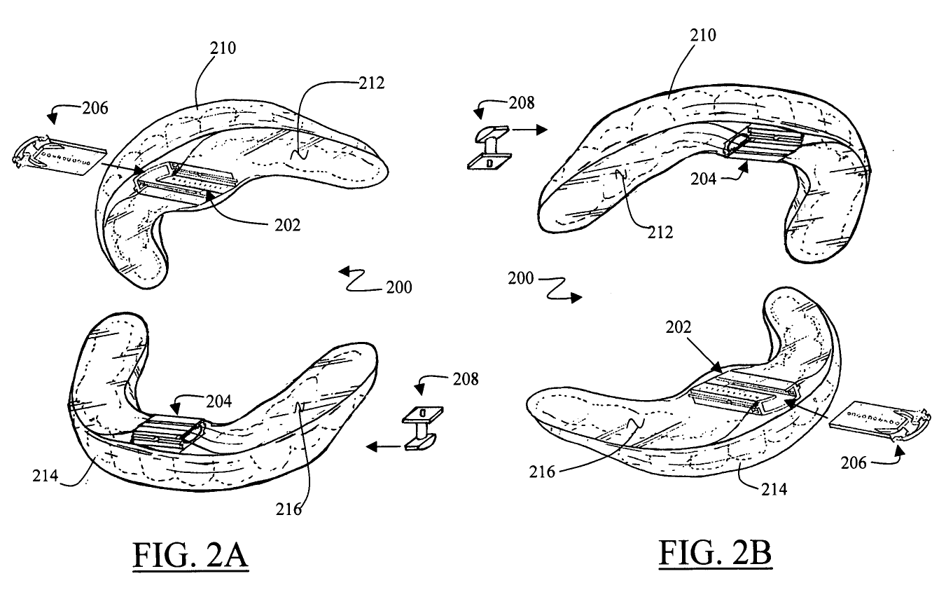

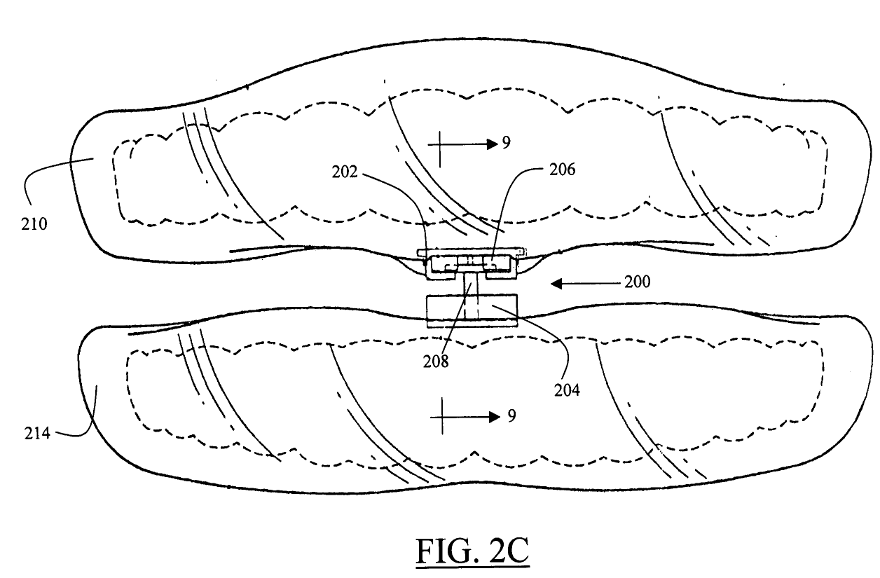

FIG. 2A illustrates a general overview of an intra-oral appliance in accordance with the present invention, including an adjustable connection mechanism 200 having a primary retention guide 202 that is coupled to a bottom surface 212 of a maxillary member 210, and a secondary retention guide 204 that is coupled to a bottom surface 216 of a mandibular member 214. As illustrated in FIG. 2B, the primary retention guide 202 may instead be coupled to the bottom surface 216 of the mandibular member 214, and the secondary retention guide 204 coupled to the bottom surface 212 of the maxillary member 210. Regardless of which member (210 or 214) the retention guides (202 and 204) are coupled with, the primary retention guide 202 should be aligned axial to the oral cavity, with the secondary retention guide 204 oriented substantially perpendicular to the primary retention guide 202.

FIGS. 2A and 2B further illustrate a mandibular adjuster 206 that is inserted into the primary retention guide 202, and used for facilitating an incremental movement of the mandible 118. An interlocking member 208 is inserted into the secondary retention guide 204 at one end, and the primary retention guide 202 at its other. The interlocking member 208 couples the maxillary member 210 and the mandibular member 214, and in connection with the mandibular adjuster 206, assists in the incremental movement of the mandible 118. FIG. 2C illustrates the fully assembled, adjustable connection mechanism 200 of FIG. 2A, with the maxillary member 210 and the mandibular member 214 in a coupled position.

In general, both the maxillary member 210 and the mandibular member 214 may be comprised of thermoplastic transparent material, which are processed by a laboratory technician for a custom fit for both oral arches when worn by a users. In particular, both the top and the bottom surfaces of the maxillary member 210 are customized in a well-known manner to conform to an individual's maxillary dentition, and the top and the bottom surfaces of the mandibular member 214 are customized in a well-known manner to conform to an individual's mandibular dentition.

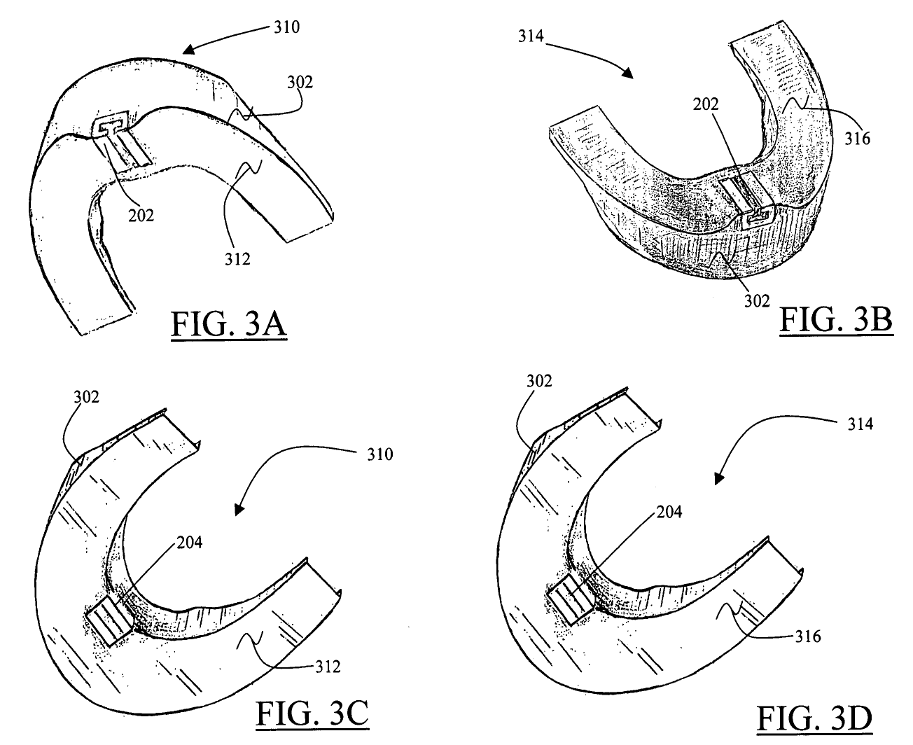

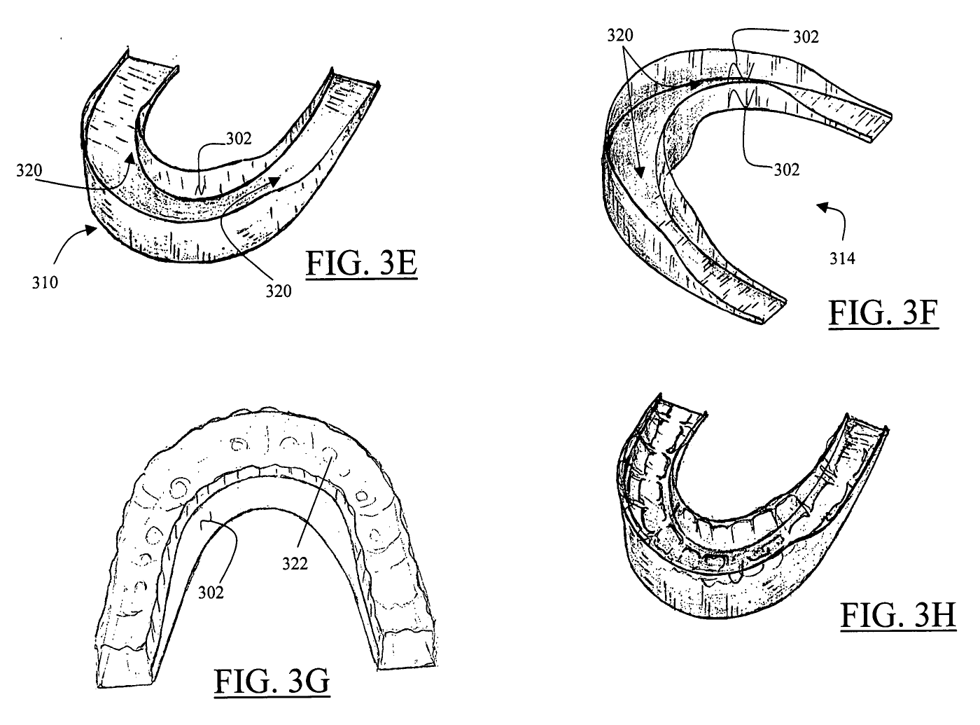

As illustrated in FIGS. 3A to 3H, instead of using the laboratory fit customized maxillary member 210 and the mandibular member 214, the adjustable connection mechanism 200 may instead be coupled to a maxillary frame 310 and a mandibular frame 314. Instead of conforming (custom fitting) to an individual's maxillary or mandibular dentition, the frames include side walls 302, and are configured to the general form of a human oral arch, and come in three industry standard sizes of small, medium, and large. Those skilled in the art would recognize that the maxillary and the mandibular frames are identical in form. FIGS. 3E to 3H illustrate the top surfaces of both the maxillary frame 310 and the mandibular frame 314, including the side walls 302 that form the channels 320. As FIGS. 3G and 3H illustrate, the channels 320 are used for containing impression material 322 that can conform to the maxillary and the mandibular dentition, after curing. The impression material 322 may be comprised of a quick impression or a boil-and-fit material, both of which are well known, and cure at room temperature.

Referring back to FIGS. 3A and 3B, the primary retention guide 202 may be coupled to a bottom surface 312 of the maxillary frame 310, or the bottom surface 316 of the mandibular frame 314. FIGS. 3C and 3D illustrate the secondary retention guide 204 coupled to the bottom surface 312 of the maxillary frame 310, or the bottom surface 316 of the mandibular frame 314. As with custom fit maxillary member 210 or the mandibular member 214, regardless of which frame (310 or 314) the retention guides (202 and 204) are coupled with, the primary retention guide 202 should be aligned axial to the oral cavity, with the secondary retention guide 204 oriented substantially perpendicular to the primary retention guide 202.

(3) Explication

The following paragraphs describe in detail the various embodiments for the adjustable connection mechanism 200 of the present invention, including (A) the primary retention guide 202, (B) the secondary retention guide 204, (C) the mandibular adjuster 206, and finally (D) the interlock member 208. Different reference numbers are used for representing different embodiments of each individual component. However, when referring to the same component in a general manner, and not within the context of any particular embodiment, then the same reference number that has been used in the FIGS. 2A and 2B for each component will continue to be used throughout the remainder of the disclosure.

(A) Primary Retention Guide

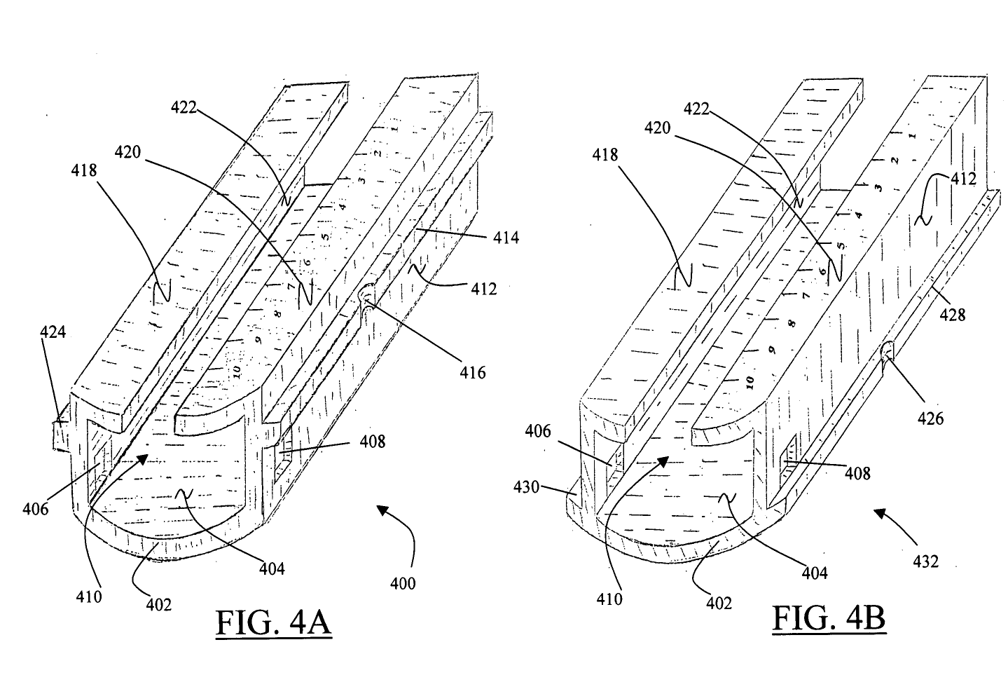

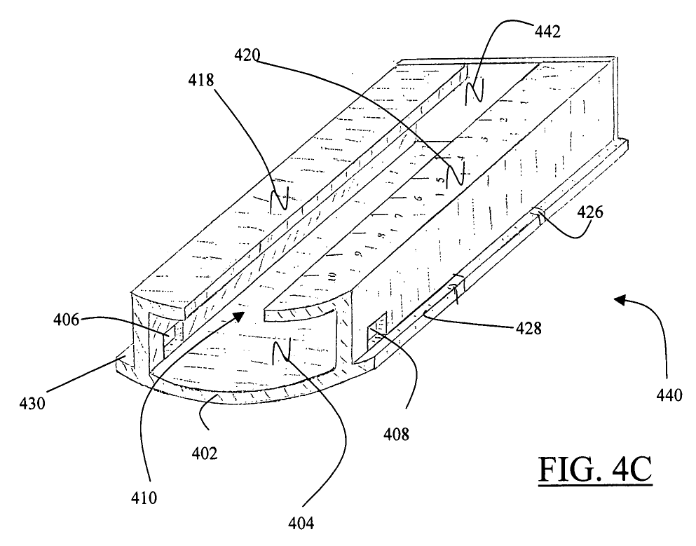

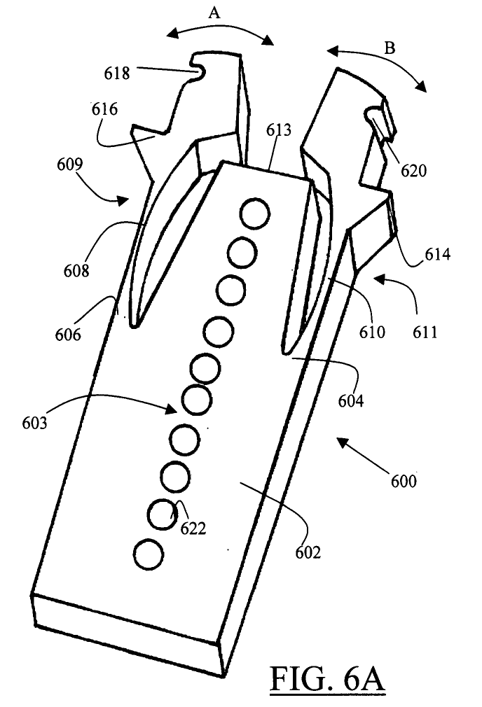

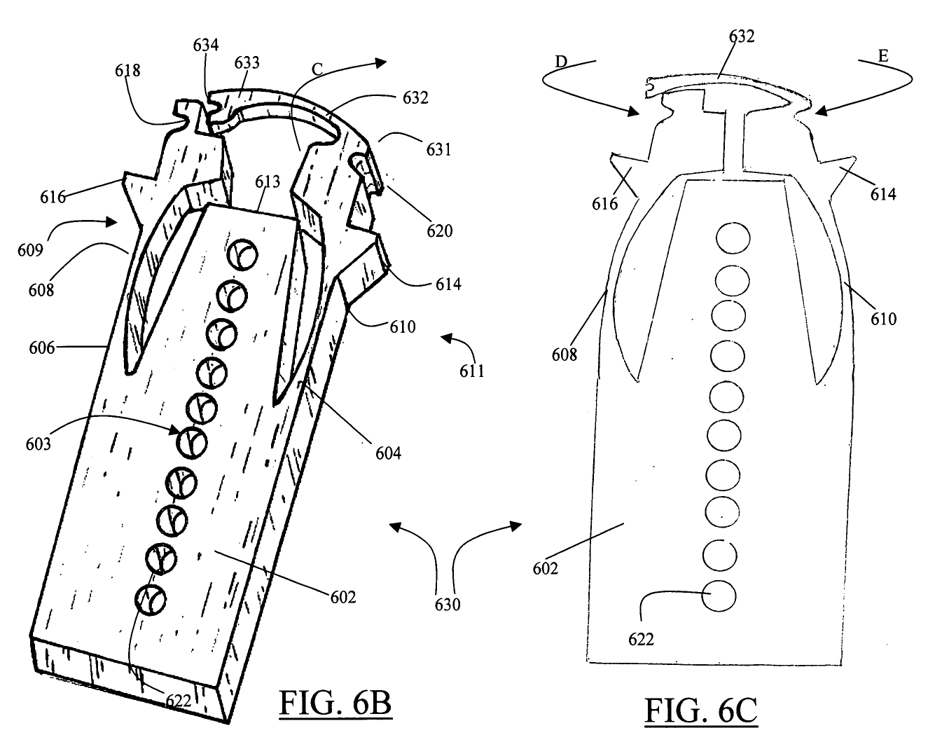

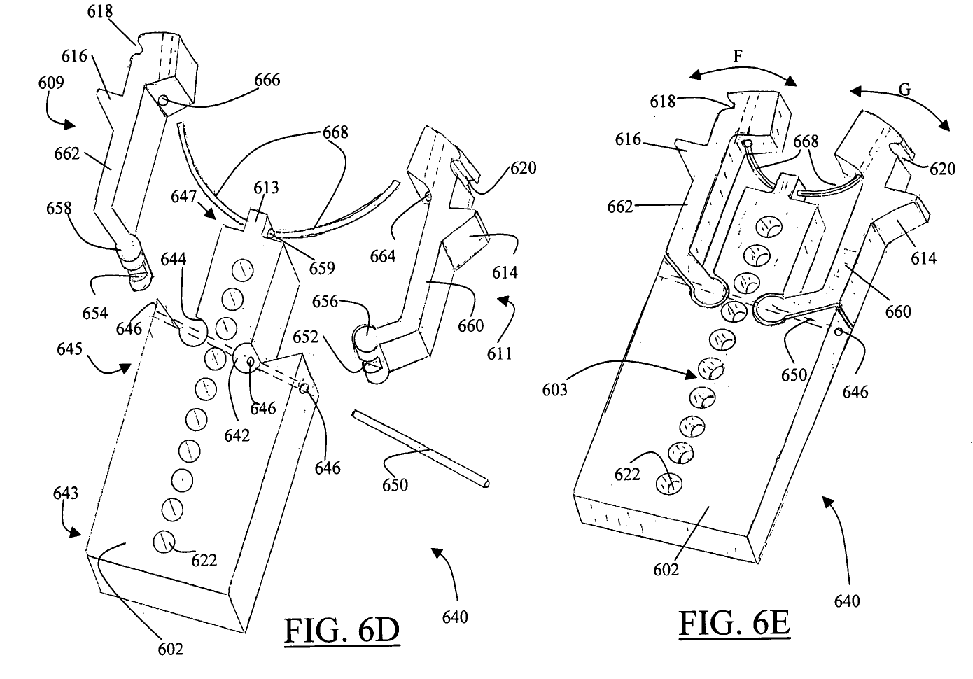

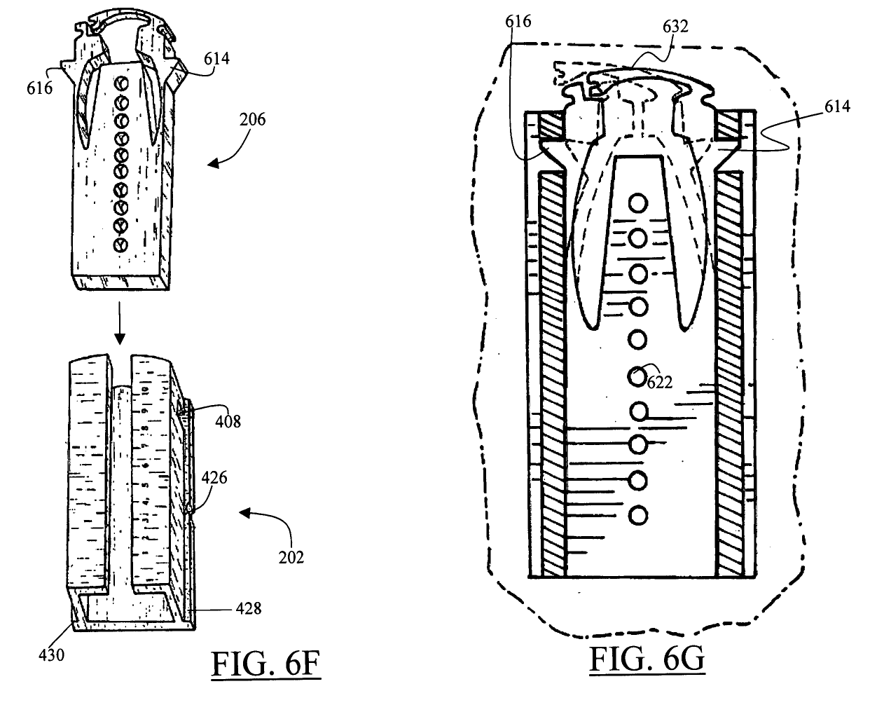

FIGS. 4A to 4C illustrate the various embodiments for the primary retention guide 202 illustrated in FIGS. 2A and 2B, which may comprise of titanium alloy or thermoplastic material. One of the functions of the primary retention guide 202 is to contain the mandibular adjuster 206, and the anchor piece of the interlock member 208, and in relation to the secondary retention guide couple the lower and the upper jaws. In general, as illustrated in FIGS. 4A to 4C, all of the embodiments of the primary retention guide 202 are comprised of a bottom side 404 that is integral with and normal to two parallel primary retention guide walls 412 and 422. The primary retention guide 202 also includes an elongated primary retention guide open channel 410 that is defined by the bottom side 404, the two walls 412 and 422, and two opposing primary retention guide flanges 420 and 418 that are integral with and normal to the two walls 412 and 422, respectively. As illustrated, at least one primary retention guide flange top surface 420, exterior to the elongated channel 410 includes incremental indicators for gauging the incremental movement of the mandible to one of an anterior and a posterior positions. Although only ten incremental values are illustrated for clarity, finer incremental gauging values may also be used. The proximal ends of the primary retention guide walls 412 and 422 include two primary retention guide wall openings 408 and 406, respectively, for receiving a protruded piece (nubs 616 and 614 illustrated in FIGS. 6A to 6G) of the mandibular adjuster 206. The proximal end 402 of the primary retention guide is curved to conform to the oral arch.

In particular, the primary retention guide 400 illustrated in FIG. 4A is further comprised of primary retention guide side bars 414 and 424, which are integral with and are axially located along a middle of the primary retention guide walls 412 and 422, respectively, exterior to the elongated channel 410. Each of the side bars 414 and 424 are further comprised of at least one cutout section along the side bar length (only the cutout section 416 along the length of the side bar 414 is illustrated for clarity). The exterior surfaces of the primary retention guide 400, which includes the exterior of the bottom side 410, and the two walls 412 and 422, and up to and including the respective two side bars 414 and 424 may be enclosed within one of the maxillary member bottom surface 212 and the mandibular member bottom surface 216, allowing the channel 410 and the two side holes 406 and 408 to remain open for removable insertion of the mandibular adjuster and the interlock member. The primary retention guide 400 may also be enclosed within one of the maxillary frame bottom surface 312 and the mandibular frame bottom surface 316 in similar manner. The cutout sections of the side bars 414 and 424 function to frictionally secure the primary retention guide 400 within the maxillary or the mandibular member or frame. That is, the cutout sections facilitate in preventing the anterior and posterior movements of the primary retention guide 400 within the maxillary or the mandibular member or frame.

FIG. 4B illustrates another embodiment of the primary retention guide 432 with at least two of a primary retention guide bottom side perimeters 428 and 430 extend beyond the primary retention guide walls 412 and 422, respectively. The two extended perimeters 428 and 430 are functionally equivalent to the side bars 414 and 424 illustrated in FIG. 4A. The extended perimeters 428 and 430 are further comprised of at least one cutout section along each of their lengths (only the cutout section 426 along the length of the extended perimeter 428 is illustrated for clarity). The exterior surfaces of the primary retention guide 432, which includes the exterior of the bottom side 410, the two extended perimeters 428 and 430, and parts of the two walls 412 and 422 may be enclosed within one of the maxillary member bottom surface 212 and the mandibular member bottom surface 216, allowing the channel 410 and the two side holes 406 and 408 to remain open for removable insertion of the mandibular adjuster and the interlock member. The primary retention guide 432 may also be enclosed within one of the maxillary frame bottom surface 312 and the mandibular frame bottom surface 316 in similar manner. FIG. 4C illustrates yet another embodiment of the primary retention guide 440 with a distal end wall 442 that may completely or partially close the distal end of the channel 410. It should be noted that although the distal end wall 442 is illustrated with the embodiment that includes extended bottom side perimeters 428 and 430, it would be obvious to those skilled in the art to also use the wall 442 with the primary retention guide 400, which is illustrated in FIG. 4A.

(B) Secondary Retention Guide

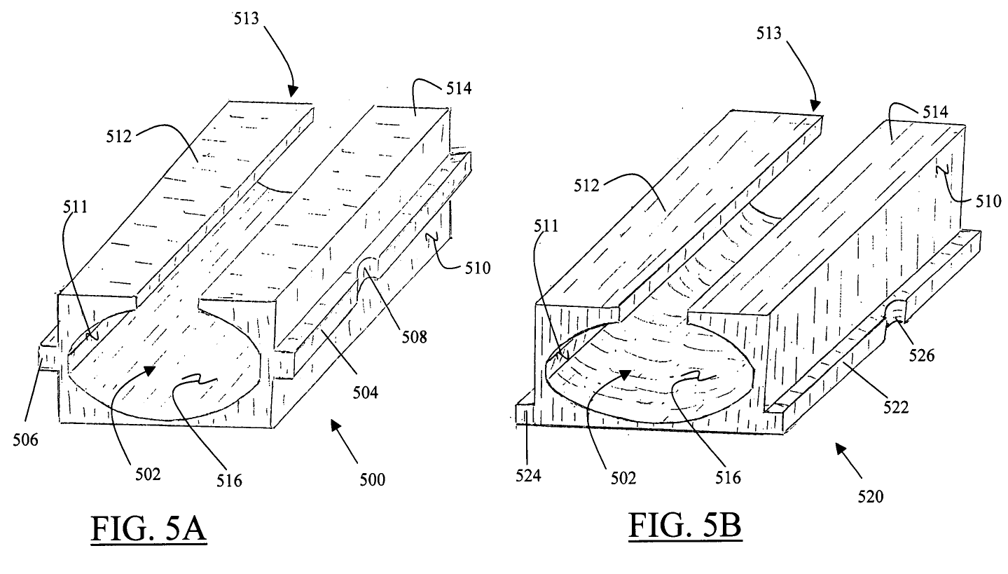

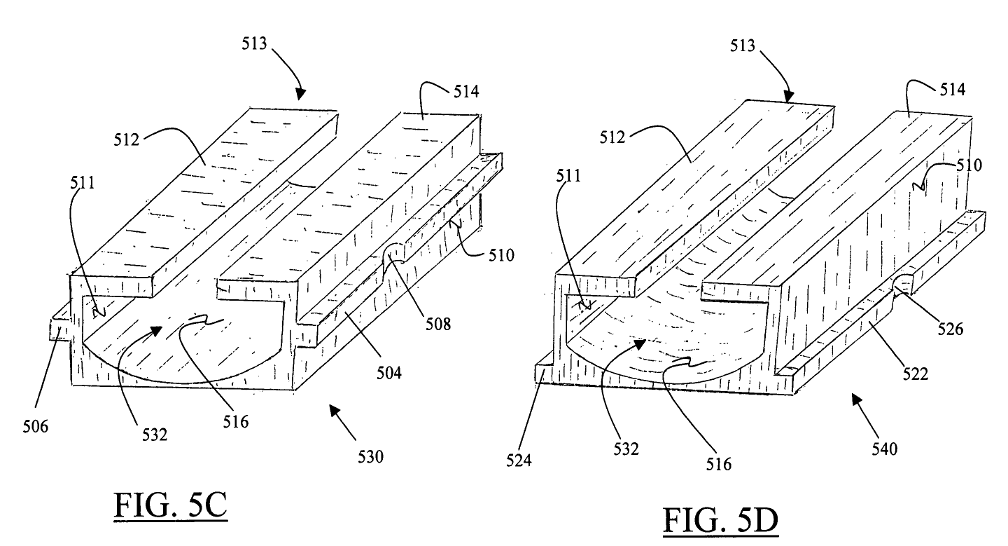

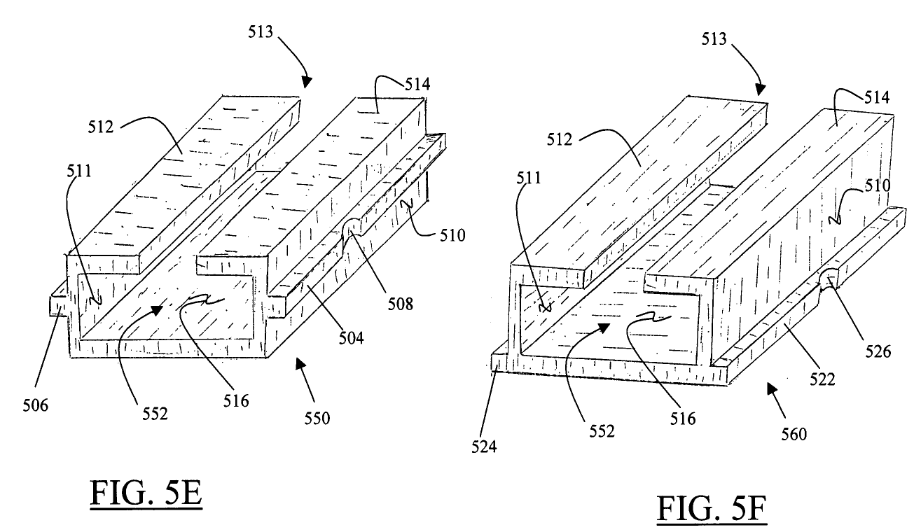

FIGS. 5A to 5F illustrate the various embodiments for the secondary retention guide 204 illustrated in FIGS. 2A and 2B, which may comprise of titanium alloy or thermoplastic material. One of the functions of the secondary retention guide 204 is to contain the headpiece of the interlock member 208, and in relation to the primary retention guide 202 couple the upper and lower jaws. In general, as illustrated in FIGS. 5A to 5F, all of the embodiments of the secondary retention guide 204 are comprised of a bottom side 516 that is integral with and normal to two secondary retention guide walls 510 and 511, and further include two opposing secondary retention guide flanges 514 and 512 that are integral with and normal to the walls 510 and 511, respectively. Although not illustrated, the distal end 513 of the secondary retention guide 204 may be completely or partially closed, similar to that of the primary retention guide 440, which is illustrated in FIG. 4C.

In particular, as illustrated in FIG. 5A, the secondary retention guide 500 is further comprised of an elongated secondary retention guide open channel 502 that is oval or round shaped, and is defined by the bottom side 516, the two walls 510 and 511, and two opposing flanges 514 and 512. As further illustrated, the walls 510 and 511 are further comprised of secondary retention guide side bars 504 and 506, respectively, which are integral with and are axially located along a middle of the respective walls 510 and 511, exterior to the oval channel 502. Each of the side bars 504 and 506 are further comprised of at least one cutout section along the side bar length (only the cutout section 508 along the length of the side bar 504 is illustrated for clarity). The exterior surfaces of the secondary retention guide 500, which includes the exterior of the bottom side 516, and the two walls 510 and 511, and up to and including the respective two side bars 504 and 506 may be enclosed within one of the maxillary member bottom surface 212 and the mandibular member bottom surface 216, allowing the channel 502 to remain open for removable insertion of the one end of the interlock member. The secondary retention guide 500 may also be enclosed within one of the maxillary frame bottom surface 312 and the mandibular frame bottom surface 316 in similar manner. The cutout sections of the side bars 504 and 506 frictionally secure the secondary retention guide 500 within the maxillary or the mandibular member or frame. That is, the cutout sections facilitate in preventing the lateral movement of the secondary retention guide 500 within the maxillary or the mandibular member or frame.

FIG. 5B illustrates another embodiment of the secondary retention guide 520 with at least two of a secondary retention guide bottom side perimeters 522 and 524 extend beyond the walls 510 and 511. The two extended perimeters 522 and 524 are functionally equivalent to the side bars 504 and 506 illustrated in FIG. 5A. The extended perimeters 522 and 524 are further comprised of at least one cutout section along each of their lengths (only the cutout section 526 along the length of the extended perimeter 522 is illustrated for clarity.) The exterior surfaces of the secondary retention guide 520, which includes the exterior of the bottom side 516, the two extended perimeters 522 and 524, and parts of the two walls 510 and 511 may be enclosed within one of the maxillary member bottom surface 212 and the mandibular member bottom surface 216, allowing the channel 502 to remain open for removable insertion of the one end of the interlock member. The secondary retention guide 520 may also be enclosed within one of the maxillary frame bottom surface 312 and the mandibular frame bottom surface 316 in similar manner.

FIG. 5C illustrates another embodiment of the secondary retention guide 530, which is similar to the secondary retention guide 500 illustrated in FIG. 5A, but with the difference of an elongated secondary retention guide open channel 532 that is semi-circularly shaped. FIG. 5D is similar to FIG. 5C, but without the side bars 504 and 506, and includes instead the two extended perimeters 522 and 524, with their respective cutout sections, similar to FIG. 5B.

FIG. 5E illustrates another embodiment of the secondary retention guide 550, which is similar to the secondary retention guides 500 and 530 illustrated in the respective FIGS. 5A and 5C, but with the difference of an elongated secondary retention guide open channel 552 that is rectangular or square shaped. FIG. 5F is similar to FIG. 5E, but without the side bars 504 and 506, and includes instead the two extended perimeters 522 and 524, with their respective cutout sections, similar to FIGS. 5B and 5D. Although not illustrated, it should be obvious to one of ordinary skilled that the secondary retention guide channel inner circumference may also be configured into other forms.

(C) Mandibular Adjuster

FIGS. 6A to 6E illustrate the various embodiments for the mandibular adjuster 206 illustrated in FIGS. 2A and 2B, all of which are comprised of titanium alloy. One of the functions of the mandibular adjuster 206 is to facilitate the means for an incremental movement of the mandible in the posterior and anterior positions. In particular, FIG. 6A illustrates a mandibular adjuster 600 comprised of a base 602 having at least one aperture 622 along an axial midsection 613. Due to the strength of the titanium alloy, the distances 603 between apertures 622 may be reduced to allow a closer alignment of the holes 622. The closer arrangement (or grouping) of the apertures 622 allows for a greater number of holes 622 to be used along the axial midsection 613 for a finer adjustment (positioning) of the mandible.

The adjuster 600 further includes a first flexible arm 609 and a second flexible arm 611 having respective first and second flexible arm distal ends 606 and 604, which are coupled to the base 602, and respective, free, first and second flexible arm proximal ends for allowing movement of both arms 609 and 611 inwardly, towards the midsection 613 of the base 602. The midsections 608 and 610 of the respective arms 609 and 611 are contoured to allow the movement of the arms. As illustrated, the distal ends 606 and 604 of the respective arms 609 and 611 are wider, and become narrower at a middle section 608 and 610, and again wider at proximal ends of the arms 609 and 611. The narrower midsections 608 and 610 allow the titanium alloy composed arms to be flexible and to continue to maintain their original structure when at rest. The thickness of the arms 609 and 611 at the midsections 608 and 610 depend on the lengths of the arms desired. The use of longer arms may require the use of wider midsections 608 and 610 for maintaining the original structure (or shape) of the arms when at rest. The opposite is also true in that the use of shorter arms may require the use of narrower midsections 608 and 610 for better flexibility.

Both the first and the second arms 609 and 611 further include respective nubs 616 and 614, protruded for engaging the primary retention guide wall apertures 408 and 406 for removabley securing the mandibular adjuster 600 to the primary retention guide 202. The arms 609 and 611 further include respective tabs 618 and 620, which are used for griping and for moving the arms 609 and 611 inwardly towards the midsection 613 of the mandibular adjuster 600, in the directions indicated by the arrows A and B, for allowing insertion and removal of the mandibular adjuster 600 within the primary retention guide 202.

FIGS. 6B and 6C illustrate another embodiment of the mandibular adjuster 206. The mandibular adjuster 630 illustrated in FIGS. 6B and 6C includes a mandibular adjuster safety lock handle 632 having a safety handle proximal end 631 integral with the second flexible arm proximal end 611, and further has a free safety handle distal end 633. The free safety handle distal end 633 includes a tab 634 to allow a user to grasp the safety handle 632 and extend it away from the base 602, in the direction indicated by the arrow C. The free safety handle distal end 633 allows the inward movement of both the first and the second flexible arms 609 and 611 towards the midsection 613, indicated by the arrows D and E, when the distal end 633 is at an extended, open position (illustrated in FIG. 6C). On the other hand, as illustrated in FIG. 6B, the free distal end 633 will block the inward movement of both the first and second flexible arms 609 and 611 towards the midsection 613 when the distal end 633 is at a rest position. Although the safety lock handle 632 is illustrated and described as being integral with the second flexible arm proximal end, it should be obvious to those skilled in the art that the safety lock handle 632 may instead easily be made integral with the first flexible arm proximal end.

FIGS. 6D and 6E illustrate yet another embodiment of the mandibular adjuster 206, with FIG. 6D illustrating an unassembled adjuster 640 and FIG. 6E illustrating the assembled adjuster 640. The mandibular adjuster 640 uses titanium alloy wire 650 and titanium alloy spring 668 for the connection and movement of the adjuster arms 609 and 611. The mandibular adjuster 640 is comprised of base 602 that includes a distal 643, middle 645, and proximal 647 sections. The middle section 645 of base 602 includes a support hole 646, which is made perpendicular to the axial midsection 613, for inserting the support wire 650 through, as illustrated. The middle section 645 further includes two cylindrically concave female receiving couplers 644 and 642 for receiving the distal ends 658 and 656 of the respective two arms 609 and 611. The distal ends 658 and 656 are comprised of cylindrical male couplers for frictionally mating the two respective female receiving couplers 644 and 646. The arm distal end male couplers 658 and 656 further include respective cutout sections 654 and 652 for forming a passage for allowing the support wire 650 to pass through, thereby preventing a disjoining of the arms 609 and 611 from the base 602 when assembled. The proximal section 647 of the base 602 includes a midsection hole 659, which is made perpendicular to the axial midsection 613 for inserting a titanium alloy spring wire 668 through. The proximal ends of the two arms 609 and 611 include respective two apertures 666 and 664 for receiving the free ends of the spring wire 668 for a connection, as illustrated. As with the other mandibular adjuster embodiments of the present invention, the axial midsection 613 of adjuster 640 also includes at least one aperture 622 for positioning the mandible.

The spring wire connection and the frictionally coupled arm distal ends allow for the movement of the two arms 609 and 611 inwardly towards the midsection 613 in the directions indicated by the arrows F and G, illustrated in FIG. 6E. Tabs 618 and 620 are used for griping the arms 609 and 611 for movement, allowing for the insertion and removal of the adjuster 640 within the primary retention guide 202. The nubs 616 and 614 are used for engaging the mandibular adjuster 640 with the primary retention guide wall openings 406 and 408 for removabley securing the adjuster 640 within the primary retention guide. As illustrated in FIGS. 6F and 6G, when the adjuster 206 is inserted into the primary retention guide 202, the two protrusions or nubs 616 and 614 located at a proximal end of the adjuster 206 snap (or lock) into the two openings 406 and 408 located at a proximal end of the primary retention guide 202.

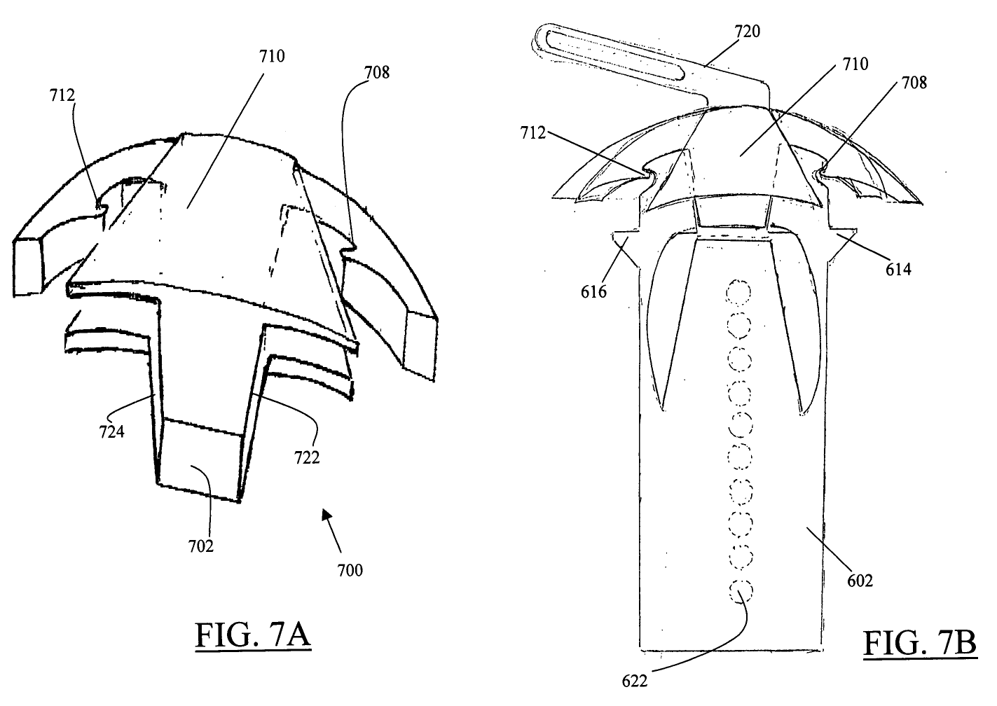

Although the nubs 616 and 614 of the mandibular adjuster 600 illustrated in FIG. 6A, and the mandibular adjuster 640 illustrated in FIGS. 6D and 6E can be used to removably secure the adjusters to the primary retention guide as described above, an optional safety cap illustrated in FIGS. 7A and 7B may also be used as an added security to further secure these mandibular adjusters within the primary retention guide. As illustrated in FIG. 7A and 7B, the safety cap 710, which is comprised of thermoplastic material, includes protrusions 712 and 708 that mate with respective tabs 618 and 620 of the mandibular adjusters 600 and 640. The distal end 702 of the safety cap 710 abuts the axial midsection 613 of the adjusters 600 and 640, with the two sides 724 and 722 of the safety cap 710 contacting the proximal ends of the respective arms 609 and 611 of the adjusters. The safety cap 710 further includes a safety cap string 720 that may be placed around the interlocking member 208.

(D) Interlock Member

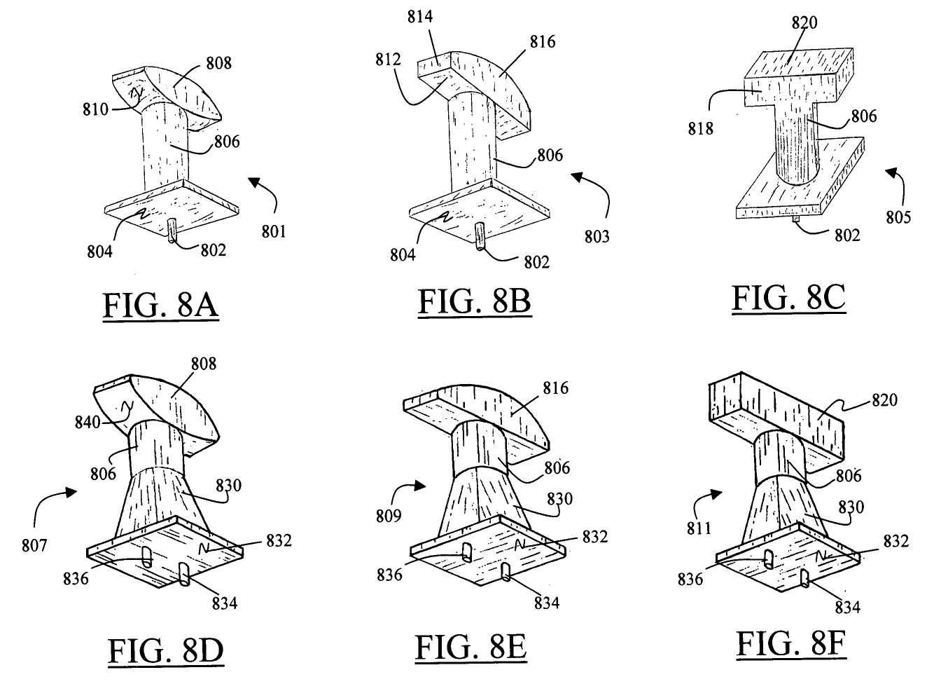

FIGS. 8A to 8F illustrate the various embodiments for the interlock member 208 illustrated in FIGS. 2A and 2B, which are single piece units, integrally comprise of titanium alloy (FIGS. 8A to 8C) or thermoplastic material (FIGS. 8D to 8F). In general, the interlock member 208 functions to couple the primary retention guide 202 to the secondary retention guide 204, and in relation to the mandibular adjuster 206 facilitates in the incremental movement of the mandible in both the anterior and posterior positions, as well as vertical and lateral movements.

As illustrated in FIGS. 8A to 8C, the interlocking member 208 has a pin 802 for removable insertion in an at least one mandibular adjuster aperture 622. The interlocking member 208 further includes the anchor piece 804 for removable insertion into the primary retention guide 202, and a head for removable insertion into the secondary retention guide 204. The anchor piece 804 of the interlocking member 208 is coupled to the pin 802 and a first end of an interlocking member support 806, with the interlocking member support 806 comprised of a cylinder, as illustrated. The anchor piece 804 is in general rectangular, and its widths (shorter sides) are configured for insertion into the primary retention guide. That is, the anchor piece 804 is inserted with its widths normal to the axial length of the primary retention guide channel 410, and its lengths (the longer sides) held in parallel to the channel walls 412 and 422. This arrangement abuts the lengths of the anchor piece parallel against the inner channel walls 412 and 422 to prevent the interlock member to move or rotate within the primary retention guide. Accordingly, the anchor piece 804 (and the pin 802) are used for securing the interlock member in the primary retention guide.

The interlock member support 806 is available in three fixed, different height and width (diameter) sizes to facilitate varying vertical and lateral movement of the mandible for a more comfortable fit. The three different cylindrical configuration of the support 806 allows room for the secondary retention guide inner channel to move (or rotate) around the support 806 to a limited extent for lateral movement of the mandible, and its three different heights enables three varying vertical distances between the maxilla and the mandible. The cylindrical support also aids in the insertion of the interlock member into the secondary retention guide. Therefore, the three different cylindrical configuration of the support 806 allow for a vertical as well as lateral movement of the mandible. The head of the interlocking member 208 is coupled to a second end of the interlocking member support 806, with an outer form of the head configured as one of a round or oval 808, semi-circular 816, or square or rectangular 820 forms as illustrated in the respective FIGS. 8A, 8B, and 8C for the respective interlock members 801, 803, and 805.

FIGS. 8D to 8F illustrate another set of embodiments for the interlock member 208, all of which are comprised of thermoplastic material. To ensure appropriate strength and impact characteristics against pressures exerted by the lower and upper jaws, the interlocking member support of these embodiments is comprised of an upper cylinder section 806, and a lower trapezoidal pyramid section 830. The pyramidal section 830 provides a wider base for the interlock member support to improve its strength and impact characteristics. In addition, in these embodiments, two pins 836 and 834 are used that can divide the exerted forces of the lower and upper jaws to prevent the breakage of the thermoplastic pins. As with the embodiments illustrated in FIGS. 8A to 8C, the head of the interlocking member 208 of these embodiments is coupled to a second end of the interlocking member support 806, with an outer form of the head configured as one of a round or oval 808, semi-circular 816, or square or rectangular 820 forms as illustrated in the respective FIGS. 8D, 8E, and 8F for the respective interlock members 807, 809, and 811.

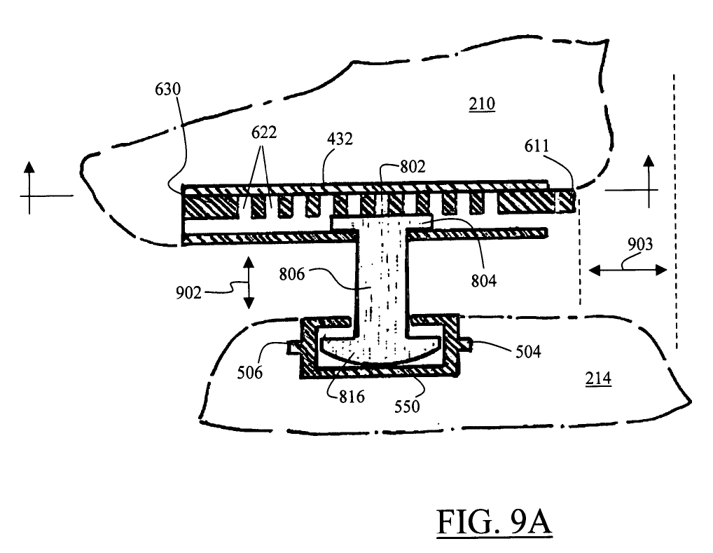

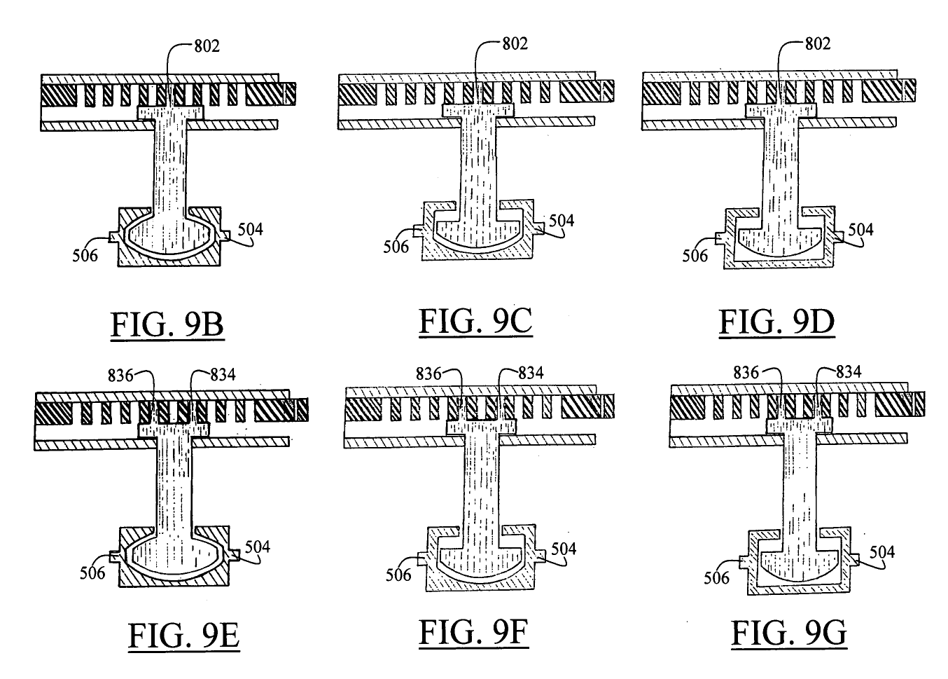

FIGS. 9A to 9G illustrate a sectional view of the primary retention guide 202 and the interlock member 208 as used in FIGS. 2A and 2C, as taken in the direction of arrows 9-9 of FIG. 2C. In particular, FIG. 9A illustrates the primary retention guide 432 axially coupled to the oral cavity to a maxillary member 210, and a secondary retention guide 550 coupled to the mandibular member 214, with the secondary retention guide 550 oriented substantially perpendicular to the primary retention guide 432. Further illustrated is the mandibular adjuster 630, which is removably inserted into the primary retention guide 432 for incremental movement of the mandible to one of posterior and anterior positions indicated by the arrow 903. The illustrated interlocking member 803 includes a pin 802 for removable insertion in an at least one mandibular adjuster aperture 622. The interlock member 803 further includes the anchor piece 804 for removable insertion into the primary retention guide 432, and a head 816 for removable insertion into the secondary retention guide 550 to interlock the primary retention guide 432 with the secondary retention guide 550, and facilitate in moving the mandible to one of an anterior and posterior positions. In addition, vertical and lateral movements of the mandible (indicated by arrow 902) are also possible because the interlock member support comes in three different height and width (diameter) sizes.

FIGS. 9B to 9G illustrate the same sectional view as illustrated in FIG. 9A, except that these figures illustrate the use of different embodiments of the various components of the connection mechanism 200. In general, FIGS. 9B to 9D illustrate the use of titanium composed interlock members with a single pin 802, which were illustrated in FIGS. 8A to 8C, and FIGS. 9E to 9G illustrate the use of thermoplastic composed interlock members with dual pins 836 and 834, which were illustrated in FIGS. 8D to 8E. In addition, FIGS. 9B to 9G use the particular embodiments of the secondary primary retention guide that were illustrated in FIGS. 5A, 5C, and 5E that include side bars 504 and 506, rather than the ones that have extended perimeters 522 and 524, such as that illustrated in FIG. 9A.

Although the invention has been described in language specific to structural features and or methodological steps, it is to be understood that the invention defined in the appended claims is not necessarily limited to the specific features or steps described. Rather, the specific features and steps are disclosed as preferred forms of implementing the claimed invention. Therefore, while illustrative embodiments of the invention have been described, numerous variations and alternative embodiments will occur to those skilled in the art. For example, the size of the adjuster mechanism and the number of apertures thereon may be varied. The forms of the primary and secondary retention guide channels (the inner circumference) may be varied, including the form of the head for the interlock member. The thermoplastic material mentioned in the explicatory section of the detailed description of the invention may comprise of polyketones, the non-limiting examples of which may include polyaryletherketones (PEK), which are repeating ether and ketone groups combined by phenly rings, polyetheretherketones (PEEK), which are repeating monomers of two ether groups and ketone group, and polyetherketoneketones (PEKK), which are repeating monomers of one ether group and two ketone groups. In addition, other materials with various combinations of the ether and ketone groups may be designed and used, the non-limiting combination example of which may include poly [ether] [ketone] [ether] [ketone] [ketone]. In fact, any material, including ceramics, which can provide excellent flexure, impact, and tensile characteristics appropriate for use within the oral cavity environment, may be used. That is, approved material having the appropriate characteristics to withstand the pressures exerted by the upper and lower jaws, as well as the existing environmental conditions of the oral cavity may be used for the primary retention guide, the secondary retention guide, the interlock member, and the optional safety cap. The primary retention guide, the secondary retention guide, the interlock member, and the optional safety cap need not be made from the same material. Such variations and alternate embodiments are contemplated, and can be made without departing from the spirit and scope of the invention.

What is claimed is:

1. An intra-oral device, comprising:
a connecting mechanism for releasably coupling a maxillary member and a mandibular member, including:
a primary retention guide for coupling to one of said maxillary member and said mandibular member, axial to oral cavity;
a secondary retention guide for coupling to said other one of said maxillary member and said mandibular member, with said secondary retention guide oriented substantially perpendicular to said primary retention guide;
a mandibular adjuster comprised of titanium alloy, having a mandibular adjuster safety lock handle at a madibular adjuster proximal end, removably inserted into said primary retention guide for incremental movement of a mandible; and
an interlocking member having at least one pin for removable insertion in an at least one mandibular adjuster aperture, and having an anchor piece for removable insertion into said primary retention guide, and having a head for removable insertion into said secondary retention guide;
whereby said connecting mechanism allows for vertical, lateral, anterior, and posterior movement of said mandible.

2. The intra-oral device as set forth in claim 1, wherein said maxillary member includes a maxillary member top surface and a maxillary member bottom surface customized for conforming to an individual's maxillary dentition; and
said mandibular member includes a mandibular member top surface and a mandibular member bottom surface customized for conforming to an individual's mandibular dentition.

3. The intra-oral device as set forth in claim 1, wherein said maxillary member includes a maxillary frame having a maxillary frame top surface and a maxillary frame bottom surface for conforming to a maxillary oral arch; and
said mandibular member includes a mandibular frame having a mandibular frame top surface and a mandibular frame bottom surface for conforming to a mandibular oral arch.

4. The intra-oral device as set forth in claim 3, wherein said maxillary frame top surface includes maxillary top surface side walls forming a maxillary top surface channel for containing impression material that can conform to maxillary dentition, and
said mandibular frame top surface includes mandibular top surface side walls forming a mandibular top surface channel for containing impression material that can conform to mandibular dentition.

5. The intra-oral device as set forth in claim 4, wherein said impression material is comprised of one of a quick impression material and a boil-and-fit material that cures at room temperature.

6. The intra-oral device as set forth in claim 1, wherein said primary retention guide includes a primary retention guide bottom side that is integral with and normal to two parallel primary retention guide walls.

7. The intra-oral device as set forth in claim 2, wherein said primary retention guide includes a primary retention guide bottom side that is integral with and normal to two parallel primary retention guide walls, with said primary retention guide bottom side and said two primary retention guide walls enclosed within one of said maxillary member bottom surface and said mandibular member bottom surface.

8. The intra-oral device as set forth in claim 3, wherein said primary retention guide includes a primary retention guide bottom side that is integral with and normal to two parallel primary retention guide walls, with said primary retention guide bottom side and said two primary retention guide walls enclosed within one of said maxillary frame bottom surface and said mandibular frame bottom surface.

9. The intra-oral device as set forth in claim 1, wherein said secondary retention guide includes a secondary retention guide bottom side that is integral with and normal to two secondary retention guide walls.

10. The intra-oral device as set forth in claim 2, wherein said secondary retention guide includes a secondary retention guide bottom side that is integral with and normal to two secondary retention guide walls, with said secondary retention guide bottom side and said two secondary retention guide walls enclosed within one of said maxillary member bottom surface and said mandibular member bottom surface.

11. The intra-oral device as set forth in claim 3, wherein said secondary retention guide includes a secondary retention guide bottom side that is integral with and normal to two secondary retention guide walls, with said secondary retention guide bottom side and said two secondary retention guide walls enclosed within one of said maxillary frame bottom surface and said mandibular frame bottom surface.

12. The intra-oral device as set forth in claim 6, wherein said primary retention guide is comprised of an elongated primary retention guide open channel that is defined by said primary retention guide bottom side, said two primary retention guide walls, and two opposing primary retention guide flanges that are integral with and normal to said two primary retention guide walls.

13. The intra-oral device as set forth in claim 12, wherein at least one primary retention guide flange top surface, exterior to said elongated primary retention guide open channel includes incremental indicators for gauging said incremental move of said mandible to one of an anterior and a posterior positions.

14. The intra-oral device as set forth in claim 9, wherein said secondary retention guide is comprised of an elongated secondary retention guide open channel that is defined by said secondary retention guide bottom side, said two secondary retention guide walls, and two opposing secondary retention guide flanges that are integral with and normal to said two secondary retention guide walls.

15. The intra-oral device as set forth in claim 6, wherein said primary retention guide walls are comprised of primary retention guide wall openings at a primary retention guide wall proximal end for receiving a protruded piece of said mandibular adjuster.

16. The intra-oral device as set forth in claim 12, wherein said primary retention guide walls are further comprised of primary retention guide side bars, which are integral with and are axially along a middle of said primary retention guide walls, exterior to said elongated primary retention guide open channel.

17. The intra-oral device as set forth in claim 14, wherein said secondary retention guide walls are further comprised of secondary retention guide side bars, which are integral with and are axially along a middle of said secondary retention guide walls, exterior to said elongated secondary retention guide open channel.

18. The intra-oral device as set forth in claim 16, wherein said primary retention guide side bars are further comprised of at least one cutout section along a primary retention guide side bar length.

19. The intra-oral device as set forth in claim 17, wherein secondary retention guide side bars are further comprised of at least one cutout section along a secondary retention guide side bar length.

20. The intra-oral device as set forth in claim 6, wherein at least two of a primary retention guide bottom side perimeters of said primary retention guide bottom side extend beyond said primary retention guide walls.

21. The intra-oral device as set forth in claim 9, wherein at least two of a secondary retention guide bottom side perimeters of said secondary retention guide bottom side extend beyond said secondary retention guide walls.

22. The intra-oral device as set forth in claim 20, wherein said at least two of said primary retention guide bottom side perimeters include at least one cutout section

23. The intra-oral device as set forth in claim 21, wherein said at least two of said secondary retention guide bottom side perimeters include at least one cutout section.

24. The intra-oral device as set forth in claim 1, wherein a primary retention guide proximal end of said primary retention guide is curved to conform to an oral arch.

25. The intra-oral device as set forth in claim 1, wherein a primary retention guide distal end of said primary retention guide and a secondary retention guide distal end of said secondary retention guide is partially closed.

26. The intra-oral device as set forth in claim 1, wherein a secondary retention guide channel inner circumference of said secondary retention guide is configured as one of a round, rectangular, square, and oval forms.

27. The intra-oral device as set forth in claim 1, wherein said mandibular adjuster is comprised of:
a support base;
a midsection having at least one aperture, comprising a midsection distal end integral with and forming a first side of said support base, and further comprising a midsection proximal end;
a first flexible arm having a first flexible arm distal end integral with a second side of said support base, and a free, first flexible arm proximal end for allowing movement of said first flexible arm inwardly towards said midsection;
a second flexible arm having a second flexible arm distal end integral with a third side of said support base, and a free, second flexible arm proximal end for allowing movement of said second flexible arm inwardly towards said midsection;
whereby said first and said second flexible arms are moved for allowing said mandibular adjuster to be removabley inserted into said primary retention guide.

28. The intra-oral device as set forth in claim 27, wherein said first flexible arm proximal end includes a first flexible arm tab and a first flexible arm nub, and said second flexible arm proximal end includes a second flexible arm tab and a second flexible arm nub,
whereby said first flexible arm tab and said second flexible arm tab are used for griping and for moving said first flexible arm and said second flexible arm inwardly towards said midsection of said mandibular adjuster for allowing insertion and removal of said mandibular adjuster within said primary retention guide; and
whereby said first flexible arm nub and said second flexible arm nub are used for engaging said mandibular adjuster with said primary retention guide wall openings for removabley securing said mandibular adjuster to said primary retention guide.

29. The intra-oral device as set forth in claim 27, wherein said mandibular adjuster safety lock handle having a safety handle proximal end integral with one of said first flexible arm proximal end and said second flexible arm proximal end, and a free safety handle distal end;
whereby said free safety handle distal end blocks said inward movement of said first flexible arm and said second flexible arm towards said midsection when said free safety handle distal end is at a rest position.

30. The intra-oral device as set forth in claim 29, wherein said free safety handle distal end allows said inward movement of said first flexible arm and said second flexible arm towards said midsection when said free safety handle distal end is at an extended, open position.

31. The intra-oral device as set forth in claim 1, wherein said anchor piece of said interlocking member is coupled to said at least one pin and a first end of an interlocking member support, with said interlocking member support comprised of a cylinder.

32. The intra-oral device as set forth in claim 1, wherein said head of said interlocking member is coupled to a second end of an interlocking member support, with an outer form of said head of said interlocking member configured as one of a round, rectangular, square, and oval forms.

33. The intra-oral device as set forth in claim 1, wherein said connection mechanism, including said primary retention guide, said secondary retention guide, and said interlocking member are comprised of titanium alloy.

34. The intra-oral device as set forth in claim 1, wherein said connection mechanism, including said primary retention guide, said secondary retention guide, and said interlocking member are comprised of thermoplastic material.

35. The intra-oral device as set forth in claim 34, wherein said thermoplastic material is comprised of polyketones.

36. The intra-oral device as set forth in claim 35, wherein said polyketones include one of polyaryletherketones (PEK), polyetheretherketones (PEEK), and polyetherketoneketones (PEKK) material.

37. A method for caring for obstructive sleep disorder breathing by adjusting a patient's mandible, comprising the acts of:
providing a connecting mechanism for releasably coupling a maxillary member and a mandibular member, including:
providing a primary retention guide for coupling to one of said maxillary member and said mandibular member, axial to oral cavity;
proving a secondary retention guide for coupling to said other one of said maxillary member and said mandibular member, with said secondary retention guide oriented substantially perpendicular to said primary retention guide;
providing a mandibular adjuster comprised of titanium alloy, having a mandibular adjuster safety lock handle at a madibular adjuster proximal end, removably inserted into said primary retention guide for incremental movement of a mandible; and
providing an interlocking member having a pin for removable insertion in an at least one mandibular adjuster aperture, and having an anchor piece for removable insertion into said primary retention guide, and having a head for removable insertion into said secondary retention guide;
whereby said connecting mechanism allows for vertical, lateral, anterior, and posterior movement of said mandible.

38. An intra-oral device, comprising:
a connecting mechanism for releasably coupling a maxillary member and a mandibular member, including:
a primary retention guide that is comprised of one of a titanium alloy and thermoplastic material, for coupling to one of said maxillary member and said mandibular member, axial to oral cavity;
a secondary retention guide that is comprised of one of a titanium alloy and thermoplastic material, for coupling to said other one of said maxillary member and said mandibular member, with said secondary retention guide oriented substantially perpendicular to said primary retention guide;
a mandibular adjuster that is comprised of titanium alloy, removably inserted into said primary retention guide for incremental movement of a mandible; and
an interlocking member that is comprised of one of a titanium alloy and thermoplastic material, having a pin for removable insertion in an at least one mandibular adjuster aperture, and having an anchor piece for removable insertion into said primary retention guide, and having a head for removable insertion into said secondary retention guide;
whereby said connecting mechanism allows for vertical, lateral, anterior, and posterior movement of said mandible.

39. The intra-oral device as set forth in claim 38, wherein said mandibular adjuster is comprised of:
a support base;
a midsection having at least one aperture, comprising a midsection distal end integral with and forming a first side of said support base, and further comprising a midsection proximal end;
a first flexible arm having a first flexible arm distal end integral with a second side of said support base, and a free, first flexible arm proximal end for allowing movement of said first flexible arm inwardly towards said midsection;
a second flexible arm having a second flexible arm distal end integral with a third side of said support base, and a free, second flexible arm proximal end for allowing movement of said second flexible arm inwardly towards said midsection;
whereby said first and said second flexible arms are moved for allowing said mandibular adjuster to be removabley inserted into said primary retention guide.

40. The intra-oral device as set forth in claim 39, wherein said first flexible arm proximal end includes a first flexible arm tab and a first flexible arm nub, and said second flexible arm proximal end includes a second flexible arm tab and a second flexible arm nub,
whereby said first flexible arm tab and said second flexible arm tab are used for griping and for moving said first flexible arm and said second flexible arm inwardly towards said midsection of said mandibular adjuster for allowing insertion and removal of said mandibular adjuster within said primary retention guide; and
whereby said first flexible arm nub and said second flexible arm nub are used for engaging said mandibular adjuster with said primary retention guide wall openings for removabley securing said mandibular adjuster to said primary retention guide.

41. The intra-oral device as set forth in claim 38, wherein said mandibular adjuster is comprised of:
a support base having a support hole through a first side of said support base for inserting a support wire through;
a midsection having at least one aperture, comprising a midsection distal end integral with a second side of said support base for forming two female receiving couplers, and a midsection proximal end having a midsection hole through a midsection length for inserting a spring wire through;
two arms having an arm proximal end for connection to said spring wire and an arm distal end comprised of a male coupler for frictionally mating said support base female receiving couplers;
said arm distal end male coupler of said two arms having a cutout section for forming a passage for allowing said support wire to pass through said passage for preventing a disjoining of said arms from said support base;
whereby said spring wire connection at said arm proximal end and said frictionally coupled arm distal end allow for movement of said two arms inwardly towards said midsection for allowing said mandibular adjuster to be inserted into said primary retention guide.

42. The intra-oral device as set forth in claim 41, wherein said arm proximal end of each arm further includes a tab for moving each arm inwardly towards said midsection of said mandibular adjuster for allowing insertion and removal of said mandibular adjuster within said primary retention guide; and
nubs for engaging said mandibular adjuster with primary retention guide wall openings for removabley securing said mandibular adjuster within said primary retention guide.

43. The intra-oral device as set forth in claim 38, wherein said anchor piece of said interlocking member is coupled to at least one pin and a first end of an interlocking member support, with said interlocking member support comprised of an upper cylinder section, and a lower trapezoidal pyramid section.

44. The intra-oral device as set forth in claim 38, wherein said head of said interlocking member is coupled to a second end of an interlocking member support, with an outer form of said head of said interlocking member configured as one of a round, rectangular, square, and oval forms.

45. The intra-oral device as set forth in claim 38, wherein said intra-oral device further includes a removable safety cap comprised of thermoplastic material, conformed to fit a mandibular adjuster proximal end, and covering a primary retention guide proximal end, including an interlocking safety string placed around said interlocking member for securing said mandibular adjuster inside said primary retention guide;
